(19) United States
(12) Patent Application Publication
(10) Pub. No.: US 2021/0241192 A1
(43) Pub. Date: Aug. 5, 2021

(54) POLICY-BASED COMPLETION OF THIRD PARTY RISK ASSESSMENTS

(71) Applicant: RSA Security LLC, Bedford, MA (US)

(72) Inventors: Brian C. Mullins, Burlington, MA (US); Victor Malchikov, Foster City, CA (US)

(21) Appl. No.: 16/778,107

(22) Filed: Jan. 31, 2020

(51) Int. Cl. G06Q 10/06

(52) U.S. Cl. CPC G06Q 10/0635; G06Q 10/0637; G06Q 10/067

(57) ABSTRACT

Techniques are provided for policy-based completion of risk assessments. One method comprises obtaining, from a risk assessment creator, a risk assessment comprising a question and a corresponding risk assessment completion policy for the question, wherein the question is processed by a risk assessment completion processing system in accordance with the corresponding risk assessment completion policy and the corresponding risk assessment completion policy comprises a trigger and one or more corresponding actions to perform when the trigger is satisfied; monitoring, by the risk assessment completion processing system, one or more responses from a risk assessment responder to the at least one question; and performing the one or more corresponding actions when the is detected. For multiple questions, the corresponding risk assessment completion policy may prioritize the multiple questions. For multiple triggers, the corresponding actions may be performed when any one of the multiple triggers is satisfied.

### FIELD

The field relates generally to information processing techniques, and more particularly to a processing of risk assessments.

### BACKGROUND

Risk assessments, typically comprising a number of questions, are often used by companies to assess the risk posed by third party vendors and other potential business partners. Thus, prior to establishing or modifying a business relationship, a risk assessment often helps one business to assess the risk that may be incurred by choosing the other business as a business partner. For example, a credit card company seeking a new vendor to produce credit cards on its behalf may need to understand the risk of working with a particular credit card producer. Risk assessments often seek to provide answers related to internal processes of a vendor, such as how a given vendor handles sensitive customer data.

Vendors complete risk assessments as part of the process of growing their business. Many vendors have multiple risk assessments in process at any given time. Risk assessments typically include a significant number of questions and can take a considerable amount of time to complete (typically, on the order of days or weeks), often involving a number of employees to complete the responses. Large enterprises often manage thousands of vendors. It is often important for providers and vendors to prepare and complete risk assessments, respectively, as efficiently as possible.

A need exists for techniques for policy-based completion of risk assessments.

### SUMMARY

In one embodiment, a method comprises obtaining, from a risk assessment creator, a risk assessment comprising at least one question and a corresponding risk assessment completion policy for the at least one question, wherein the at least one question is processed by a risk assessment completion processing system in accordance with the corresponding risk assessment completion policy, wherein the corresponding risk assessment completion policy comprises at least one trigger and one or more corresponding actions to perform when the at least one trigger is satisfied; monitoring, by the risk assessment completion processing system, one or more responses from a risk assessment responder to the at least one question; and performing the one or more corresponding actions when the at least one trigger is detected.

In some embodiments, the at least one question comprises a plurality of questions and the corresponding risk assessment completion policy prioritizes the plurality of questions. The at least one trigger may comprise a plurality of triggers and the one or more corresponding actions may be performed when any one of the plurality of triggers is satisfied. The one or more corresponding actions to perform when the at least one trigger is satisfied may influence a control flow for a completion of the risk assessment.

Other illustrative embodiments include, without limitation, apparatus, systems, methods and computer program products comprising processor-readable storage media.

### BRIEF DESCRIPTION OF THE DRAWINGS

FIG. 1 illustrates a risk assessment submission and response platform, according to at least one embodiment of the disclosure;

FIG. 2 illustrates an exemplary template for rule-based completion policies, according to one or more embodiments of the disclosure;

FIG. 3 illustrates a JSON (JavaScript Object Notation) structure for an exemplary fail-fast risk assessment completion policy, according to an embodiment;

FIG. 4 illustrates a JSON structure for an exemplary pause assessment completion policy, according to one or more embodiments of the disclosure;

FIG. 5 is a sample table illustrating a mapping of zero or more risk assessment questions to one or more defined corresponding policy tags, according to some embodiments of the disclosure;

FIG. 6 illustrates a JSON structure for an exemplary group risk assessment completion policy based on a specified maximum number of incorrect answers, according to at least one embodiment;

FIG. 7 illustrates a JSON structure for an exemplary group risk assessment completion policy based on a specified maximum percentage of incorrect answers, according to one embodiment;

FIG. 8 illustrates a JSON structure for an exemplary question scoring risk assessment completion policy based on a defined numerical scoring for one or more questions of a risk assessment, according to one embodiment;

FIG. 9 illustrates a JSON structure for an exemplary granular risk assessment completion policy that can be employed in conjunction with the exemplary question scoring risk assessment completion policy of FIG. 8, according to a defined numerical scoring embodiment;

FIG. 10 is a flow chart illustrating an exemplary implementation of a policy-based risk assessment completion process, according to at least one embodiment of the disclosure;

FIG. 11 illustrates an exemplary processing platform that may be used to implement at least a portion of one or more embodiments of the disclosure comprising a cloud infrastructure;

and

FIG. 12 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for policy-based completion of risk assessments.

In one or more embodiments, a risk assessment creator can specify one or more policies, such as rule-based policies, that annotate the created risk assessments with metadata specifying one or more conditions that influence the completion of the risk assessment (for example, using programmatic control, such as if/then type statements). In this manner, the risk assessment can then be administered in a way that influences and/or expedites the completion process. For example, the creator can optionally influence application control flow based upon how the responder answers questions of a given risk assessment. As used herein, the term “policy” shall encompass one or more rules and/or priorities used to implement a policy or to otherwise influence completion of a risk assessment.

In some embodiments, the disclosed rule-based policies allow risk assessments to be annotated in a way that controls the completion of risk assessment work flows as vendors (or another risk assessment responder) complete each risk assessment. Consider, for example, a fail-fast policy whereby several “deal breaker” questions are identified by the assessment provider or creator. A fail-fast policy can optionally specify that if a vendor answers any of the “deal breaker” questions incorrectly, then the assessment is automatically marked as completed (or is otherwise stopped or paused) and the risk assessment is sent back to the risk assessment provider for review. For example, the “deal breaker” questions (or a set of “deal breaker” questions) can specify one or more conditions, that when triggered or otherwise satisfied, will stop (or pause) the risk assessment (e.g., when an answer indicates a predefined warning flag or a predefined number or percentage of the “deal breaker” questions are not answered in a specified manner). In this manner, the risk assessment provider gets a completed assessment back from the responder as quickly as possible and helps the risk assessment responder by ensuring that the risk assessment responder does not waste time answering more unneeded questions. While this fail-fast policy example may be straightforward, the disclosed techniques for risk assessment submission and response allow risk assessment creators to create rules (and/or other policies) with varying degrees of complexity and granularity, as discussed further below.

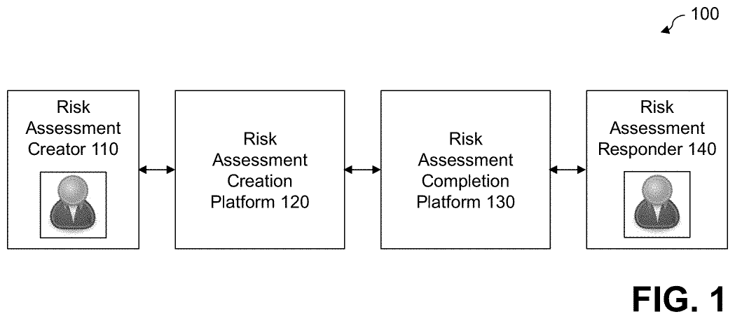

FIG. 1 illustrates a risk assessment submission and response platform 100, according to at least one embodiment of the disclosure. As shown in FIG. 1, a risk assessment creator 110 creates one or more risk assessments, optionally by means of a risk assessment creation platform 120, discussed further below. Questions in the submitted risk assessment are to be responded to (and/or otherwise processed) by a risk assessment responder 140. By introducing a rule-based completion policy as part of a submitted risk assessment, risk assessment creators 110 can tailor the completion process for risk assessment responders 140.

The risk assessment responder 140 responds to the questionnaire using a risk assessment completion platform 130. In some embodiments, the risk assessment creator 110 embeds one or more policies and/or rules to a risk assessment during creation of the risk assessment that influence how the risk assessment is completed by the risk assessment responder 140.

The risk assessment responder 140 may optionally delegate one or more responses to another party or person, such as employees of the risk assessment responder 140 (collectively, referred to hereinafter as the risk assessment responder 140). While only one instance is shown in FIG. 1 for each of the risk assessment creator 110 and the risk assessment responder 140, multiple instances of the risk assessment creator 110 and/or the risk assessment responder 140 can be present in various embodiments, as would be apparent to a person of ordinary skill in the art.

In some embodiments, the risk assessment creation platform 120 may be implemented using, for example, the RSA Archer® platform, commercially available from RSA Security LLC, of Dell EMC, Hopkinton, Mass. Generally, the exemplary RSA Archer® platform is an example of a Governance, Risk and Compliance (GRC) solution and allows vendors to complete risk assessments in a cloud-hosted portal. The risk assessment creation platform 120 may be hosted, for example, on the premises of the risk assessment creator 110 or in the cloud.

In some embodiments, the risk assessment completion platform 130 may be implemented using the techniques described herein for influencing the completion of risk assessments. The risk assessment completion platform 130 may be hosted, for example, on the premises of the risk assessment responder 140 or in the cloud. For example, in some embodiments of a risk assessment completion platform 130 implemented on the premises of the risk assessment responder 140, the risk assessment completion platform 130 could serve, for example, as an abstraction layer that can interface with various risk assessment creation platforms 120.

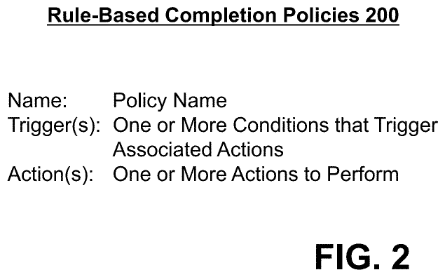

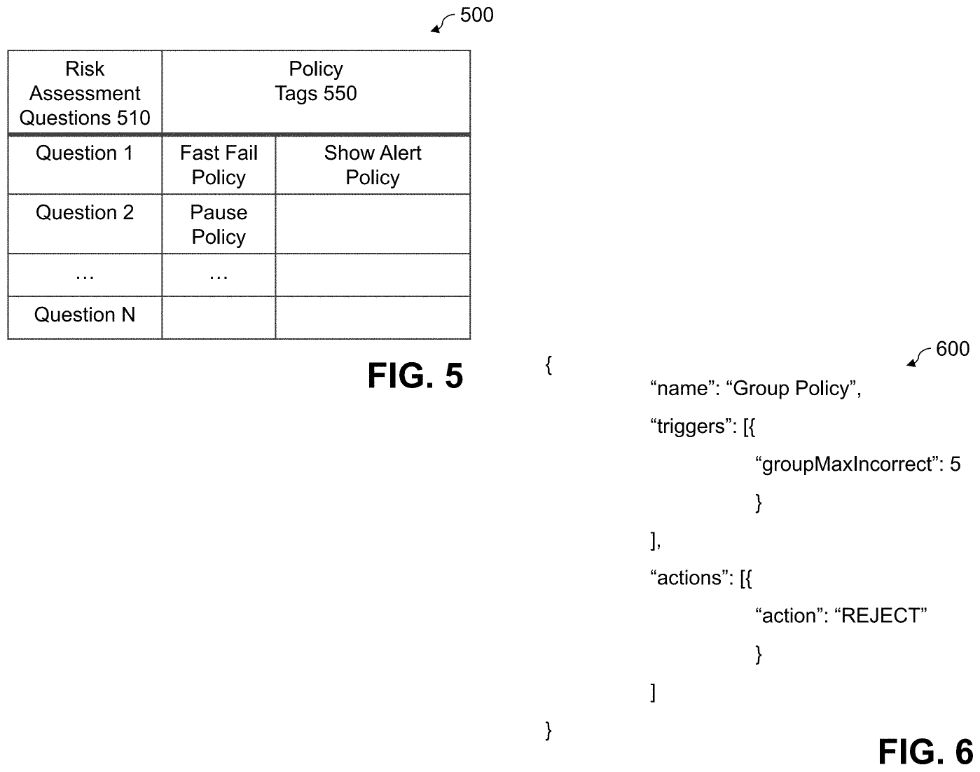

In one or more embodiments, a risk assessment comprises a list of one or more questions (each optionally having zero or more associated policies specified by the risk assessment creator 110). A risk assessment submitted by the risk assessment creator 110 comprises, for example, the following exemplary attributes for each question in the risk assessment:
ID: an identifier for each question;
Text: the text of each question;
Attributes: a set of key-value pairs describing each question, such as category; and
Policies: zero or more rule-based policies applicable to each question (as discussed further below in conjunction with, for example, FIGS. 2 and 5).

As noted above, the risk assessment creator 110 is an entity (e.g., an organization or individual) that submits a risk assessment (e.g., a questionnaire) to be completed by a designated risk assessment responder 140. The risk assessment creator 110 may be characterized in some embodiments, as follows:
ID: an identifier for the risk assessment creator 110; and
Attributes: an arbitrary set of key-value pairs describing the risk assessment creator 110, such as a provider name and/or primary office location.

As noted above, the risk assessment responder 140 is an entity that responds to a risk assessment and may optionally delegate certain responses to other entities, such as employees of the risk assessment responder 140. The risk assessment responder 140 may be characterized in one or more embodiments, as follows:
ID: an identifier for the risk assessment responder 140; and
Attributes: an arbitrary set of key-value pairs describing the risk assessment responder 140.

The risk assessment creation platform 120 and risk assessment completion platform 130 in the FIG. 1 embodiment account recovery are assumed to be implemented using at least one processing device. Each such processing device generally comprises at least one processor and an associated memory, and implements one or more functional modules for controlling certain features of the risk assessment creation platform 120 and/or the risk assessment completion platform 130. More particularly, the risk assessment creation platform 120 and/or the risk assessment completion platform 130 in this embodiment comprises a processor coupled to a memory and a network interface (not shown in FIG. 1). The processor illustratively comprises a microprocessor, a microcontroller, an application-specific integrated circuit (ASIC), a field-programmable gate array (FPGA) or other type of processing circuitry, as well as portions or combinations of such circuitry elements. The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

A user of the risk assessment submission and response platform 100 is, for example, an entity and/or person representing an organization using the risk assessment creation platform 120 (and/or the risk assessment completion platform 130). Also, it is to be appreciated that the term “user” in this context and elsewhere herein is intended to be broadly construed so as to encompass, for example, human, hardware, software or firmware entities, as well as various combinations of such entities.

A user of the risk assessment submission and response platform 100 may access the risk assessment submission and response platform 100, for example, using one or more user devices (not shown in FIG. 1). The user devices may comprise, for example, mobile telephones, laptop computers, tablet computers, desktop computers or other types of devices capable of supporting user access to network resources. Such devices are examples of what are more generally referred to herein as “processing devices.” Some of these processing devices are also generally referred to herein as “computers.” The user devices in some embodiments comprise respective computers associated with a particular company, organization or other enterprise.

The risk assessment creation platform 120 and the risk assessment completion platform 130 communicate, for example, over a computer network and/or a secure link. In some embodiments, a publish/subscribe mechanism can be used to communicate risk assessments to one or more risk assessment responders 140, and for the risk assessment creator 110 to receive responses to submitted risk assessments.

At least portions of the computer network may comprise an “enterprise network.” Numerous other operating scenarios involving a wide variety of different types and arrangements of processing devices and networks are possible, as will be appreciated by those skilled in the art. The computer network is assumed to comprise a portion of a global computer network such as the Internet, although other types of networks can be part of the computer network, including a wide area network (WAN), a local area network (LAN), a satellite network, a telephone or cable network, a cellular network, a wireless network such as a WiFi or WiMAX network, or various portions or combinations of these and other types of networks. The computer network in some embodiments therefore comprises combinations of multiple different types of networks each comprising processing devices configured to communicate using IP or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The computer network may also include one or more storage devices. The storage device can be implemented, for example, using one or more storage systems. Such storage systems can comprise any of a variety of different types of storage including network-attached storage (NAS), storage area networks (SANs), direct-attached storage (DAS) and distributed DAS, as well as combinations of these and other storage types, including software-defined storage.

Examples of particular types of storage products that can be used in implementing a given storage system in an illustrative embodiment include VNX® and Symmetrix VMAX® storage arrays, software-defined storage products such as ScaleIO™ and ViPR®, flash-based storage arrays such as DSSD™, cloud storage products such as Elastic Cloud Storage (ECS), object-based storage products such as Atmos®, scale-out all-flash storage arrays such as XtremIO™, and scale-out NAS clusters comprising Isilon® platform nodes and associated accelerators in the S-Series, X-Series and NL-Series product lines, all from EMC Corporation of Hopkinton, Mass. Combinations of multiple ones of these and other storage products can also be used in implementing a given storage system in an illustrative embodiment.

The storage device can illustratively comprise a single storage array, storage disk, storage drive or other type of storage device. Alternatively, the storage device can comprise one or more storage systems each having multiple storage devices implemented therein. The term “storage device” as used herein is therefore intended to be broadly construed. In some embodiments, a storage device may comprise a network share or possibly even an attached device such as a USB stick. Accordingly, in some embodiments, the storage device may be attached to one or more user devices in addition to or in place of being attached to the computer network. The stored files on the storage device may be encrypted using an encryption process implemented by the user to protect the stored files from unauthorized access.

FIG. 2 illustrates an exemplary template for rule-based completion policies 200, according to one or more embodiments of the disclosure. In the example of FIG. 2, the exemplary rule-based completion policies 200 comprise the following exemplary fields:

Name: policy name;

Trigger(s): one or more conditions that trigger associated actions; and

Action(s): one or more actions to perform when trigger is satisfied.

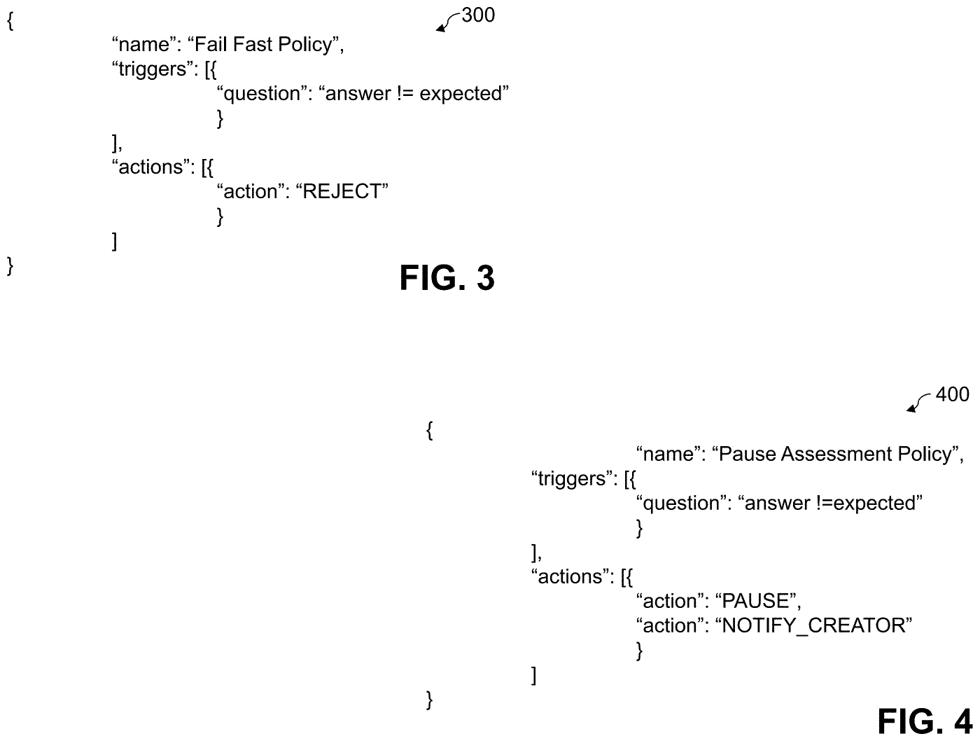

The exemplary rule-based completion policies 200 can be created, for example, using a JSON structure, such as those discussed further below in conjunction with FIGS. 3-4 and 6-9. In some embodiments, the rule-based completion policies 200 can be specified using one or more rules.

FIG. 3 illustrates a JSON structure 300 for an exemplary fail-fast risk assessment completion policy, according to an embodiment. As shown in FIG. 3, the exemplary fail-fast risk assessment completion policy specifies that when a particular question is not answered in an expected manner, the corresponding action is to reject the overall risk assessment. Thus, if the trigger conditions of not answering the question in the indicated manner are satisfied, then the corresponding actions specified in the exemplary fail-fast risk assessment completion policy will be executed.

FIG. 4 illustrates a JSON structure 400 for an exemplary pause assessment completion policy, according to one or more embodiments of the disclosure. As shown in FIG. 4, the exemplary pause assessment completion policy specifies that when a particular question is not answered in an expected manner, the corresponding multiple actions are to pause the overall risk assessment and notify the risk assessment creator 110.

FIG. 5 is a sample table 500 illustrating a mapping of zero or more risk assessment questions 510 to one or more defined corresponding policy tags 550, according to some embodiments of the disclosure. For example, as shown in FIG. 5, the sample table 500 indicates that representative risk assessment question 1 is mapped to the following defined corresponding policy tags 550: the fail-fast risk assessment completion policy of FIG. 3 and a show alert policy (not shown in the FIGS.). Thus, when question 1 is processed, the indicated policies will be enforced and any actions associated with one or more triggers satisfied in a specified policy will be performed.

In this manner, as part of the process of creating a risk assessment by the risk assessment creator 110, the risk assessment creator 110 can map each question within the risk assessment to one or many completion policies using policy tags. Tags map the question to the policy name. If more than one policy is applied to a given question, the associated actions are executed in order, in some embodiments, starting with the first listed policy. In an alternate arrangement, one or more questions of a given risk assessment can be directly specified with one or more triggers and one or more associated actions that are applicable to a given question.

Triggers

In some embodiments, it is assumed that the risk assessment completion platform 130 that evaluates the policy has knowledge of both the risk assessment questions and the allowed answers, pursuant to one or more rule-based completion policies 200. Policy triggers can optionally be setup to trigger an action based upon evaluating only one question, as discussed above in conjunction with FIG. 3. Policy triggers can also be setup to trigger an action upon evaluating all questions assigned to the same policy.

FIG. 6 illustrates a JSON structure 600 for an exemplary group risk assessment completion policy based on a specified maximum number of incorrect answers, according to at least one embodiment. As shown in FIG. 6, the exemplary group risk assessment completion policy specifies a maximum number of incorrect answers for the group. Thus, across all of the questions defined for the group, there is a specified maximum number of 5 incorrect answers, in the example of FIG. 6. Questions in the exemplary group risk assessment completion policy are specified by mapping the group policy of FIG. 6 (for example) to all of the questions in the group, using a table similar to the one shown in FIG. 5.

Thus, the one or more actions defined for the group (e.g., rejecting the risk assessment in the example of FIG. 6, upon the fifth incorrect answer, across the defined group of questions) will be executed only if more than five incorrect answers are submitted by the risk assessment responder 140, considering only questions assigned to that group policy.

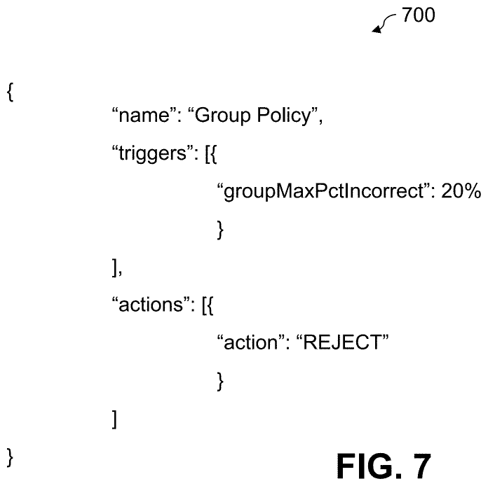

One or more aspects of the invention recognize that group policies can also be created in further variations that trigger based upon a percentage of incorrect answers in the group. FIG. 7 illustrates a JSON structure 700 for an exemplary group risk assessment completion policy based on a specified maximum percentage of incorrect answers, according to one embodiment. As shown in FIG. 7, the exemplary group risk assessment completion policy specifies a maximum percentage of incorrect answers for the group at 20%. Thus, across all of the questions defined for the group, there is a specified maximum percentage of 20% incorrect answers, in the example of FIG. 7. Questions in the exemplary group risk assessment completion policy can be specified in some embodiments by mapping the group policy of FIG. 7 (for example) to all of the questions in the group, using a table similar to the one shown in FIG. 5.

More granular scoring mechanisms for evaluating assessment answers could also be constructed by the risk assessment creator 110, as would be apparent to a person of ordinary skill in the art. For example, instead of evaluating questions in a binary manner (e.g., did the provided answer match the expected answer), questions could be scored numerically, in a similar manner as grading homework.

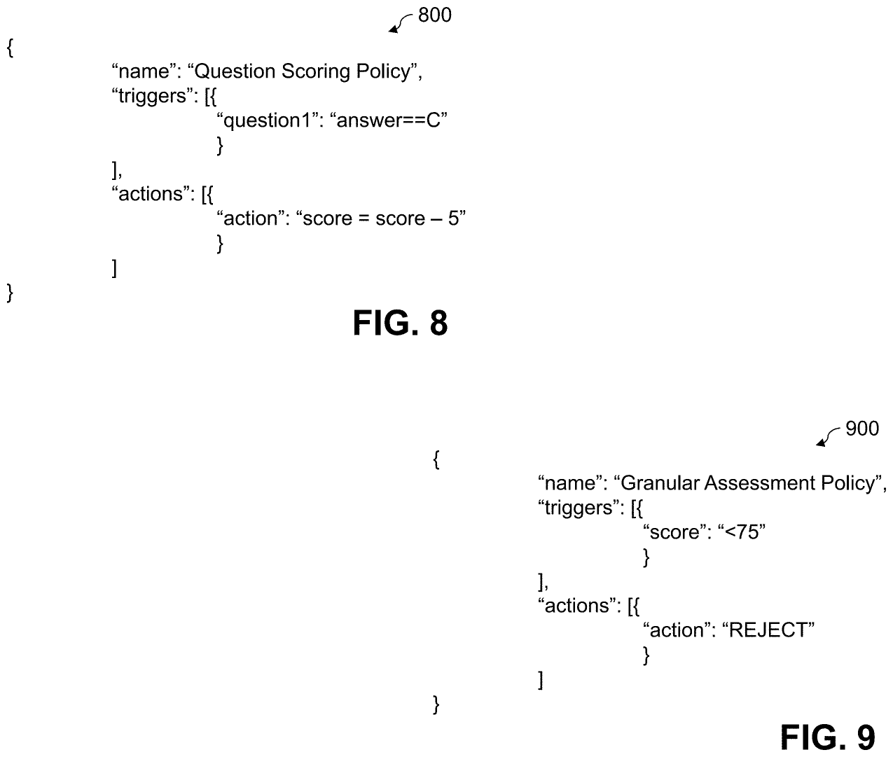

FIG. 8 illustrates a JSON structure 800 for an exemplary question scoring risk assessment completion policy based on a defined numerical scoring for one or more questions of a risk assessment, according to one embodiment. In the example of FIG. 8, the risk assessment creator 110 specified the exemplary question scoring risk assessment completion policy to require that if a first question is answered by selecting multiple choice option C (of defined multiple choice answers), then five points are deducted from the overall score of 100 available points for each risk assessment, in some embodiments.

FIG. 9 illustrates a JSON structure 900 for an exemplary granular risk assessment completion policy that can be employed in conjunction with, for example, the exemplary question scoring risk assessment completion policy of FIG. 8, according to a defined numerical scoring embodiment. In the example of FIG. 9, the risk assessment creator 110 specified the exemplary granular risk assessment completion policy to require that if the overall score is below 75 (relative to an overall score of 100 available points for each risk assessment), for example, then the action to perform when the trigger is satisfied is to reject the overall risk assessment.

The above discussion presented a number of representative examples to help illustrate the types of triggers that could be constructed, and the types of corresponding actions that are performed when the respective triggers are satisfied. The structure of the rule-based completion policies 200 in FIG. 2, for example, allows risk assessment creators 110 to construct straightforward broad rules or more granular, complex rules, as appropriate. Other structures can be employed to define the rule-based completion policies, as well as desired triggers and one or more actions to perform when a given policy is triggered, as would be apparent to a person of ordinary skill in the art.

Actions

Actions are the mechanism that customize the control-flow for how completion of a given risk assessment occurs. These actions are intended to make the completion process more efficient for both risk assessment creators 110 and risk assessment responders 140 (e.g., vendors) providing answers (or other responses) to the risk assessment. As shown in the examples presented above, actions may include automatically marking the assessment as completed with a status of rejected. Other potential actions that may be defined can include one or more of the following representative actions, which are presented without limitation:
pausing or stopping the risk assessment;
initiating a review of the risk assessment by the risk assessment creator 110;
rejecting the risk assessment; and
generating a notification (e.g., an email or a visual warning or other indication) to (a) the risk assessment creator 110 and/or (b) the risk assessment responder 140 (such as a visual pre-approval message (e.g. once a given risk assessment is at least 90% complete) or a “submit” button (e.g., once a given risk assessment is at least 95% complete, for example).

In this manner, the one or more actions that are performed when a trigger is satisfied influence a control flow for a completion of the risk assessment.

Risk Assessment Question Priority

As noted above, to further expedite the risk assessment completion process, questions (and/or one or more policies associated with a given question) could be annotated with a priority. The risk assessment completion platform 130 that hosts the risk assessment could then optionally sort questions using this priority, thereby influencing risk assessment responders 140 to begin the completion process with the highest priority items. For example, if the question prioritization was done in conjunction with a “fail fast” policy as described above in conjunction with FIG. 3, then risk assessment responders 140 (e.g., vendors) who are not a good fit for the risk assessment could complete the assessment within minutes. This could then prompt a conversation between the risk assessment creators 110 and risk assessment responders 140 before going any further with the project.

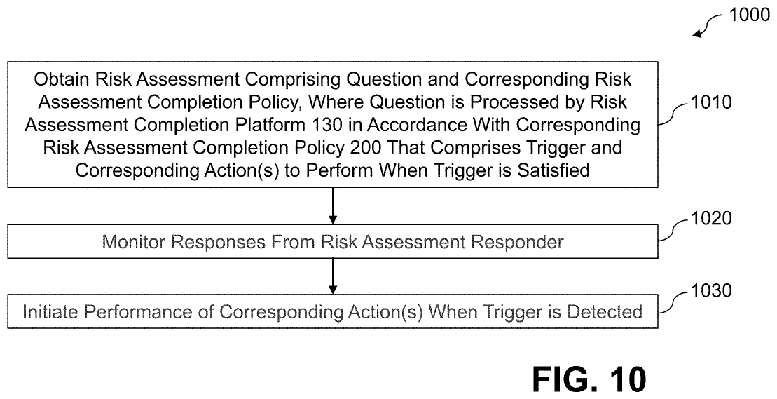

FIG. 10 is a flow chart illustrating an exemplary implementation of a policy-based risk assessment completion process 1000, according to at least one embodiment of the disclosure. As shown in FIG. 10, the exemplary policy-based risk assessment completion process 1000 initially obtains, from a risk assessment creator 110, a risk assessment during step 1010 comprising at least one question and a corresponding risk assessment completion policy 200 for the at least one question. The at least one question is processed by a risk assessment completion platform 130 in accordance with the corresponding risk assessment completion policy 200. In addition, the corresponding risk assessment completion policy 200 comprises at least one trigger and one or more corresponding actions to perform when the at least one trigger is satisfied.

The exemplary policy-based risk assessment completion process 1000 monitors, using the risk assessment completion platform 130, one or more responses from a risk assessment responder 140 to the at least one question during step 1020. Finally, the exemplary policy-based risk assessment completion process 1000 performs the one or more corresponding actions during step 1030 when the at least one trigger is detected.

One or more embodiments of the disclosure provide a mechanism for defining and enforcing rule-based risk assessment completion policies that allow risk assessment creators 110 to dictate a control-flow for how risk assessment responders 140 (e.g., vendors) to complete risk assessments, for example, in a cloud-hosted portal (e.g., the risk assessment completion platform 130).

Thus, among other benefits, the risk assessment creators 110 can influence how the risk assessments are completed, terminated, reviewed, rejected, and/or accepted, for example, in some embodiments.

One or more embodiments of the disclosure provide improved methods, apparatus and computer program products for influencing the completion of risk assessments. The foregoing applications and associated embodiments should be considered as illustrative only, and numerous other embodiments can be configured using the techniques disclosed herein, in a wide variety of different applications.

It should also be understood that the disclosed policy-based risk assessment completion techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for policy-based completion of risk assessments may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a Platform-as-a-Service (PaaS) offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based policy-based risk assessment completion engine, or portions thereof, are illustratively implemented for use by tenants of such a multi-tenant environment.

Cloud infrastructure as disclosed herein can include cloud-based systems such as Amazon Web Services (AWS), Google Cloud Platform (GCP) and Microsoft Azure. Virtual machines provided in such systems can be used to implement at least portions of a cloud-based policy-based risk assessment completion platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

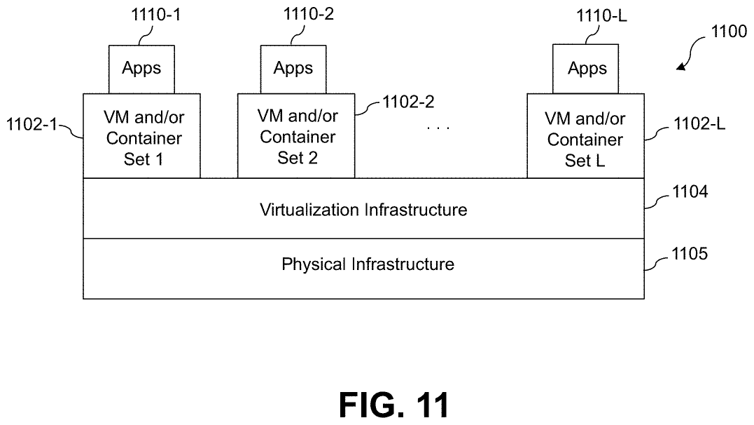

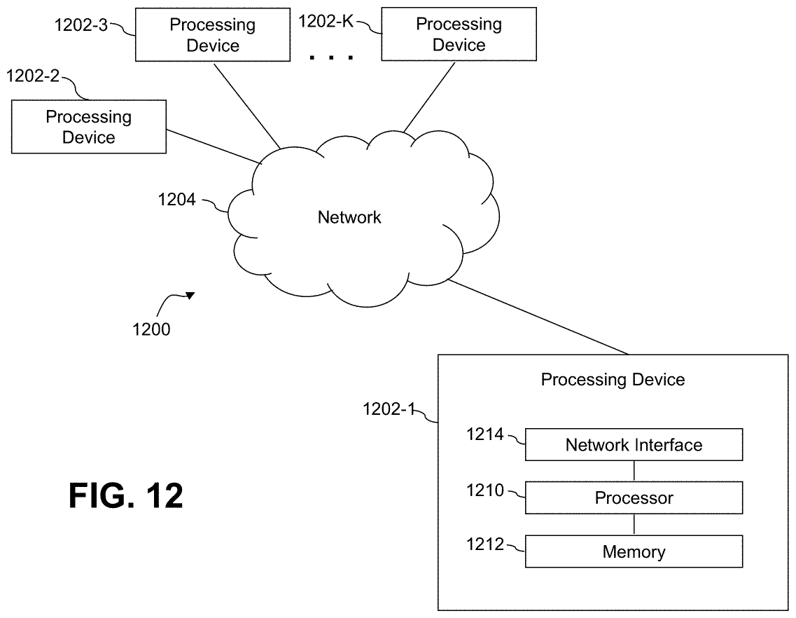

Illustrative embodiments of processing platforms will now be described in greater detail with reference to FIGS. 11 and 12. These platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that may be utilized to implement at least a portion of an information processing system, such as those shown in FIG. 1. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 may comprise respective VMs, respective sets of one or more containers, or respective sets of one or more containers running in VMs.

In some implementations of the FIG. 11 embodiment, the VMs/container sets 1102 comprise respective VMs implemented using virtualization infrastructure 1104 that comprises at least one hypervisor. Such implementations can provide policy-based risk assessment completion functionality of the type described above for one or more processes running on a given one of the VMs. For example, each of the VMs can implement policy-based risk assessment completion control logic and associated rule-based completion policy tables for providing policy-based risk assessment completion functionality for one or more processes running on that particular VM. An example of a hypervisor platform that may be used to implement a hypervisor within the virtualization infrastructure 1104 is the VMware® vSphere® which may have an associated virtual infrastructure management system such as the VMware® vCenter™. The underlying physical machines may comprise one or more distributed processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system. Such implementations can provide policy-based risk assessment completion functionality of the type described above for one or more processes running on different ones of the containers. For example, a container host device supporting multiple containers of one or more container sets can implement one or more instances of policy-based risk assessment completion control logic and associated rule-based completion policy tables for providing policy-based risk assessment completion functionality.

As is apparent from the above, one or more of the processing modules or other components of risk assessment submission and completion platform 100 may each run on a computer, server, storage device or other processing platform element. A given such element may be viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises at least a portion of the given system and includes a plurality of processing devices, denoted 1202-1, 1202-2, 1202-3, . . . 1202-K, which communicate with one another over a network 1204. The network 1204 may comprise any type of network, such as a WAN, a LAN, a satellite network, a telephone or cable network, a cellular network, a wireless network such as WiFi or WiMAX, or various portions or combinations of these and other types of networks.

The processing device 1202-1 in the processing platform 1200 comprises a processor 1210 coupled to a memory 1212. The processor 1210 may comprise a microprocessor, a microcontroller, an ASIC, a FPGA or other type of processing circuitry, as well as portions or combinations of such circuitry elements, and the memory 1212, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 11 or 12, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxBlock™, or Vblock® converged infrastructure commercially available from Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. A method, comprising:
obtaining, from a risk assessment creator, a risk assessment comprising at least one question and a corresponding risk assessment completion policy for the at least one question, wherein:
the at least one question is processed by a risk assessment completion processing system in accordance with the corresponding risk assessment completion policy, wherein the corresponding risk assessment completion policy comprises at least one trigger and one or more corresponding actions to perform when the at least one trigger is satisfied; and
the risk assessment completion policy is a rule-based completion policy created using a JSON structure, wherein the JSON structure is based on defined numerical scoring that represents how well one or more responses from a risk assessment responder complies with the rule-based completion policy, wherein the JSON structure comprises a policy name, at least one condition that triggers associated actions, and at least one action to perform;
comparing, by the risk assessment completion processing system, the one or more responses from the risk assessment responder to the at least one question in accordance with the risk assessment completion policy; and
performing the one or more corresponding actions when the at least one trigger is detected by executing the JSON structure, wherein the risk assessment completion processing system comprises at least one processing device comprising a processor coupled to a memory.

2. The method of claim 1, wherein the risk assessment responder delegates one or more responses to another party.

3. The method of claim 1, wherein the corresponding risk assessment completion policy is specified using one or more rules.

4. The method of claim 1, wherein the at least one question comprises a plurality of questions and wherein the corresponding risk assessment completion policy prioritizes the plurality of questions.

5. The method of claim 1, wherein the at least one trigger comprises a plurality of triggers and wherein the one or more corresponding actions are performed when any one of the plurality of triggers is satisfied.

6. The method of claim 1, wherein the at least one question comprises a plurality of questions, wherein one or more answers for each of the plurality of questions have one or more of a corresponding numerical score and a corresponding score deduction, and wherein the one or more conditions comprise an overall threshold score for the plurality of questions.

7. The method of claim 1, wherein the one or more corresponding actions to perform when the at least one trigger is satisfied influence a control flow for a completion of the risk assessment.

8. The method of claim 1, wherein the one or more corresponding actions to perform when the at least one trigger is satisfied includes: (i) pausing the risk assessment, (ii) initiating a review of the risk assessment by the risk assessment creator, (iii) rejecting the risk assessment, (iv) stopping the risk assessment, or (v) generating a notification to (a) the risk assessment creator or (b) the risk assessment responder.

9. The method of claim 1, wherein one or more conditions of the at least one trigger comprise: (i) responses to the risk assessment satisfying a predefined completion threshold, or (ii) responses to the risk assessment satisfying a predefined score threshold.

10. The method of claim 1, wherein the at least one question comprises a plurality of questions and wherein one or more conditions of the at least one trigger comprise: a list, a number, or a percentage of the plurality of questions that are not answered in a specified manner.

11. An apparatus comprising: at least one processing device comprising a processor coupled to a memory; the at least one processing device being configured to implement:
obtaining, from a risk assessment creator, a risk assessment comprising at least one question and a corresponding risk assessment completion policy for the at least one question, wherein the at least one question is processed by a risk assessment completion processing system in accordance with the corresponding risk assessment completion policy, wherein:
the corresponding risk assessment completion policy comprises at least one trigger and one or more corresponding actions to perform when the at least one trigger is satisfied; and
the risk assessment completion policy is a rule-base completion policy created using a JSON structure, wherein the JSON structure is based on defined numerical scoring that represents how well one or more responses from a risk assessment responder complies with the rule-based completion policy, wherein the JSON structure and comprises a policy name, at least one condition that triggers associated actions, and at least one action to perform;
comparing, by the risk assessment completion processing system, the one or more responses from the risk assessment responder to the at least one question in accordance with the risk assessment completion policy; and
performing the one or more corresponding actions when the at least one trigger is detected by executing the JSON structure.

12. The apparatus of claim 11, wherein the at least one question comprises a plurality of questions and wherein the corresponding risk assessment completion policy prioritizes the plurality of questions.

13. The apparatus of claim 11, wherein the at least one trigger comprises a plurality of triggers and wherein the one or more corresponding actions are performed when any one of the plurality of triggers is satisfied.

14. The apparatus of claim 11, wherein the one or more corresponding actions to perform when the at least one trigger is satisfied influence a control flow for a completion of the risk assessment.

15. The apparatus of claim 11, wherein one or more conditions of the at least one trigger comprise: (i) responses to the risk assessment satisfying a predefined completion threshold, or (ii) responses to the risk assessment satisfying a predefined score threshold.

16. A non-transitory processor-readable storage medium having stored therein program code of one or more software programs, wherein the program code when executed by at least one processing device causes the at least one processing device to perform:
obtaining, from a risk assessment creator, a risk assessment comprising at least one question and a corresponding risk assessment completion policy for the at least one question, wherein the at least one question is processed by a risk assessment completion processing system in accordance with the corresponding risk assessment completion policy, wherein:
the corresponding risk assessment completion policy comprises at least one trigger and one or more corresponding actions to perform when the at least one trigger is satisfied; and
the risk assessment completion policy is a rule-base completion policy created using a JSON structure, wherein the JSON structure is based on defined numerical scoring that represents how well one or more responses from a risk assessment responder complies with the rule-based completion policy, wherein the JSON structure and comprises a policy name, at least one condition that triggers associated actions, and at least one action to perform;
comparing, by the risk assessment completion processing system, the one or more responses from the risk assessment responder to the at least one question in accordance with the risk assessment completion policy; and
performing the one or more corresponding actions when the at least one trigger is detected by executing the JSON structure.

17. The non-transitory processor-readable storage medium of claim 16, wherein the at least one question comprises a plurality of questions and wherein the corresponding risk assessment completion policy prioritizes the plurality of questions.

18. The non-transitory processor-readable storage medium of claim 16, wherein the at least one trigger comprises a plurality of triggers and wherein the one or more corresponding actions are performed when any one of the plurality of triggers is satisfied.

19. The non-transitory processor-readable storage medium of claim 16, wherein the one or more corresponding actions to perform when the at least one trigger is satisfied influence a control flow for a completion of the risk assessment.

20. The non-transitory processor-readable storage medium of claim 16, wherein one or more conditions of the at least one trigger comprise: (i) responses to the risk assessment satisfying a predefined completion threshold, or (ii) responses to the risk assessment satisfying a predefined score threshold.
